(19) United States
(12) Patent Application Publication
(10) Pub. No.: US 2015/0068377 A1
(43) Pub. Date: Mar. 12, 2015

(54) CUTTING A MOVING MEDIA

(71) Applicants: David Chanclon, Barcelona (ES); Marta Ramis, Barcelona (ES); Martin Urrutia, Barcelona (ES)

(72) Inventors: David Chanclon, Barcelona (ES); Marta Ramis, Barcelona (ES); Martin Urrutia, Barcelona (ES)

(73) Assignee: HEWLETT-PACKARD DEVELOPMENT COMPANY, L.P., Houston, TX (US)

(21) Appl. No.: 14/374,152

(22) PCT Filed: Feb. 28, 2012
(86) PCT No.: PCT/US2012/026924

§ 371 Date: Jul. 23, 2014

(51) Int. Cl. B41J 11/70; B26D 5/00; B41J 11/66; B26D 1/60

(52) U.S. Cl. CPC B41J 11/706; B26D 1/605; B26D 5/00; B41J 11/663
USPC 83/37; 83/311; 83/284

(57) ABSTRACT

In one example, a cutter for cutting a moving media includes a cutting tool movable along a first straight line at a speed sufficient to cut moving media along a second straight line different from the first straight line.

### BACKGROUND

Paper and other print media for large format inkjet printers may be supplied as pre-cut sheets or rolls of flexible web. Printers printing on a media web sometimes include a cutter that automatically cuts the web into the desired size sheets before, during, or after printing.

### DRAWINGS

FIG. 1 is a block diagram illustrating an inkjet printer in which examples of a new, diagonal media cutter may be implemented.

FIG. 2 is a diagrammatic elevation view illustrating a web printer that includes a diagonal web cutter, according to one implementation of the invention.

FIG. 3 is a plan view illustrating one example of a diagonal web cutter such as might be used in the printers shown in FIGS. 1 and 2.

FIGS. 4 and 5 illustrate the operation of the diagonal cutter shown in FIG. 3.

FIGS. 6 and 7 illustrate cutting the print media at other than a square cut.

FIG. 8 is a block diagram illustrating one example of a cutter that may be used for the diagonal cutter shown in FIGS. 1-5.

FIGS. 9-12 illustrate the operation of a rotary blade cutter as one example for the diagonal cutter shown in FIGS. 1-5.

FIGS. 13 and 14 illustrate a retractable cutter blade that may be used in the cutter shown in FIGS. 9-12.

The same part numbers are used to designate the same or similar parts throughout the figures.

### DESCRIPTION

In conventional inkjet web printers, the web is stopped to allow the cutter to cut the web. The cutting operation in such printers is often quite fast compared to the printing operation and, therefore, stopping the web for cutting does not significantly reduce the throughput of the printer. However, as faster inkjet printers are developed, stopping the web for printing may significantly reduce printer throughput. Consequently, a new media cutter has been developed to allow cutting a print media web in large format inkjet printers without stopping the web during cutting. The new cutter, however, is not limited to use in inkjet printers or to cutting media webs, but may be implemented in other devices and/or for cutting sheets, webs, or other media forms. The examples and implementations described below should not be construed to limit the scope of the invention, which is defined in the Claims that follow this Description.

In one example, a new cutter for cutting a moving media includes a cutting tool driven along a straight guide line at a speed V_{C} sufficient to cut moving media along a straight cut line different from the guide line. While it is expected that the cut line will typically be perpendicular to the direction the media moves during the cutting operation, thus making a square cut, other straight cut lines are possible. For making a square cut, the guide line is oriented at an acute angle a measured with respect to the direction the media moves and the speed V_{C} of the cutting tool is determined by the equation

$${V}_{C} = \frac{{V}_{M}}{cos α}$$

where V_{M} is the speed of the media.

As used in this document, an “acute angle” means an angle less than 90° and greater than 0°.

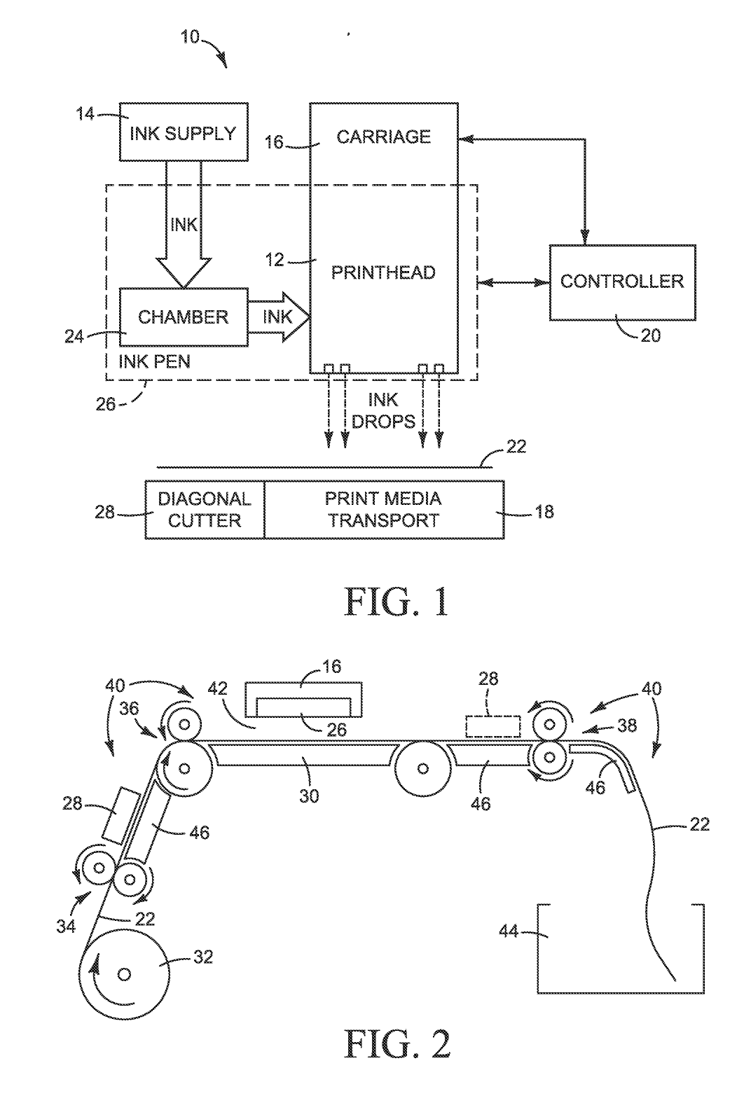

FIG. 1 is a block diagram illustrating an inkjet printer 10 in which examples of a new media cutter may be implemented. Referring to FIG. 1, inkjet printer 10 includes a printhead 12, an ink supply 14, a carriage 16, a print media transport mechanism 18 and a controller 20. Printhead 12 in FIG. 1 represents generally one or more printheads and the associated mechanical and electrical components for dispensing drops of ink on to a sheet or a continuous web of paper or other print media 22. Printhead 12 may include one or more stationary printheads that span the width of print media 22. Alternatively, printhead 12 may include one or more printheads that are scanned back and forth on carriage 16 across the width of media 22. Printhead 12 may include, for example, thermal ink dispensing elements or piezoelectric ink dispensing elements. Other printhead configurations and ink dispensing elements are possible. Controller 20 in FIG. 1 represents generally the programming, processor(s) and associated memories, and the electronic circuitry and components needed to control the operative elements of printer 10.

Ink chamber 24 and printhead 12 are usually housed together in an ink pen 26, as indicated by the dashed line in FIG. 1. Ink supply 14 supplies ink to printhead 12 through ink chamber 24. Ink supply 14, chamber 24 and printhead 12 may be housed together in an ink pen. Alternatively, ink supply 14 may be housed separate from ink chamber 24 and printhead 12, as shown, in which case ink is supplied to chamber 24 through a flexible tube or other suitable conduit. Printer 10 typically will include several ink pens 26, for example one pen for each of several colors of ink.

Media transport 18 advances print media 22 past printhead 12. For a stationary printhead 12, media transport 18 may advance media 22 continuously past printhead 12. For a scanning printhead 12, media transport 18 may advance media 22 incrementally past printhead 12, stopping as each swath is printed and then advancing media 22 for printing the next swath. Printer 10 also includes a diagonal cutter 28 for cutting print media 22. As described in detail below, cutter 28 is configured to move in a straight line and make a square cut (or other desired cut angle) without stopping media 22. While it is expected that a diagonal cutter 28 will usually be implemented in a web fed printer 10 printing on a web media 22, a diagonal cutter 28 could also be implemented in a sheet fed printer 10 printing on sheet media 22.

FIG. 2 is a diagrammatic elevation view illustrating a printer 10 that includes a diagonal web cutter 28, according to one implementation of the invention. Referring to FIG. 2, printer 10 includes, for example, a group of multiple ink pens 26 for dispensing different color inks. Ink pens 26 are mounted on a carriage 16 over a platen 30. In the example implementation shown in FIG. 2, media transport 18 in printer 10 includes a web supply roll 32 and a series of transport rollers 34, 36, and 38 for moving a media web 22 along a media path 40 from supply roll 32 over a platen 30 at print zone 42 to an output basket 44. Media guides 46 may be used to support and guide media 22 along media path 40. In one example, cutter 28 (in solid lines) is positioned upstream from print zone 42 between transport rollers 34 and 36. In another example, cutter 28 (in dashed lines) is positioned downstream from print zone 42 between transport rollers 36 and 38.

Once media web 22 is cut, the downstream, cut part of the web could be characterized as a media sheet rather than a media web, particularly for shorter lengths of cut web. For convenience, however, and to avoid confusion between the use of a cutter 28 in a web fed printer such as printer 10 shown in FIG. 2 and the use of a cutter 28 in a sheet fed printer, reference to “web” media or a media “web” means the print media in a web fed printer both before and after the web is cut and reference to a “sheet” media or a media “sheet” means the print media in a sheet fed printer both before and after a sheet is cut.

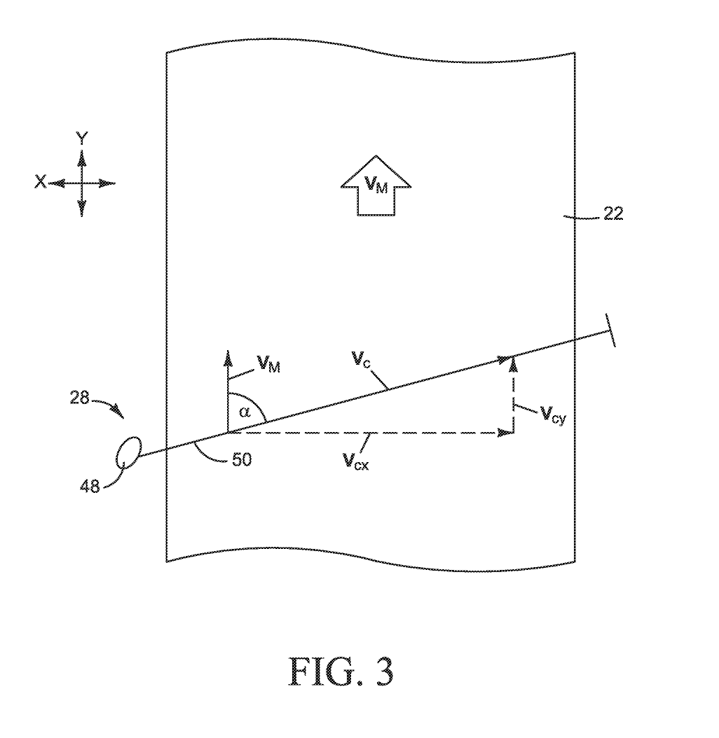

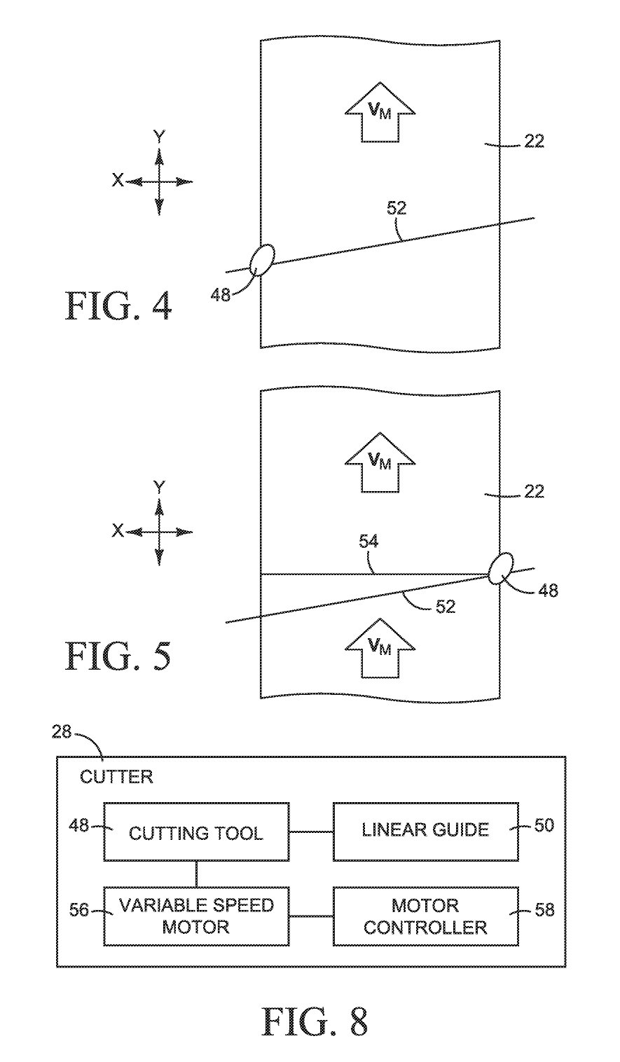

FIG. 3 is a plan view illustrating one example of a diagonal web cutter 28 such as might be used in the inkjet printers shown in FIGS. 1 and 2. FIGS. 4 and 5 illustrate the operation of cutter 28 shown in FIG. 3. Referring to FIG. 3-5, cutter 28 includes a cutting tool 48 and a stationary, linear guide 50. “Stationary” in this context means the guide is stationary during a cutting operation, and does not mean the guide is immovable. Indeed, it is expected that the position of guide 50 will be adjustable in some implementations. Guide 50 is oriented at an acute angle α measured with respect to the direction media 22 moves past guide 50. Thus, cutting tool 48 moves along a straight guide line 52 (FIG. 4) in a direction not perpendicular to the advancing media 22. It has been demonstrated that cutting tool 48 and media 22 can be moved along linear paths at the same time in different directions to make a square cut line 54 (FIG. 5) without stopping media 22 during the cutting operation.

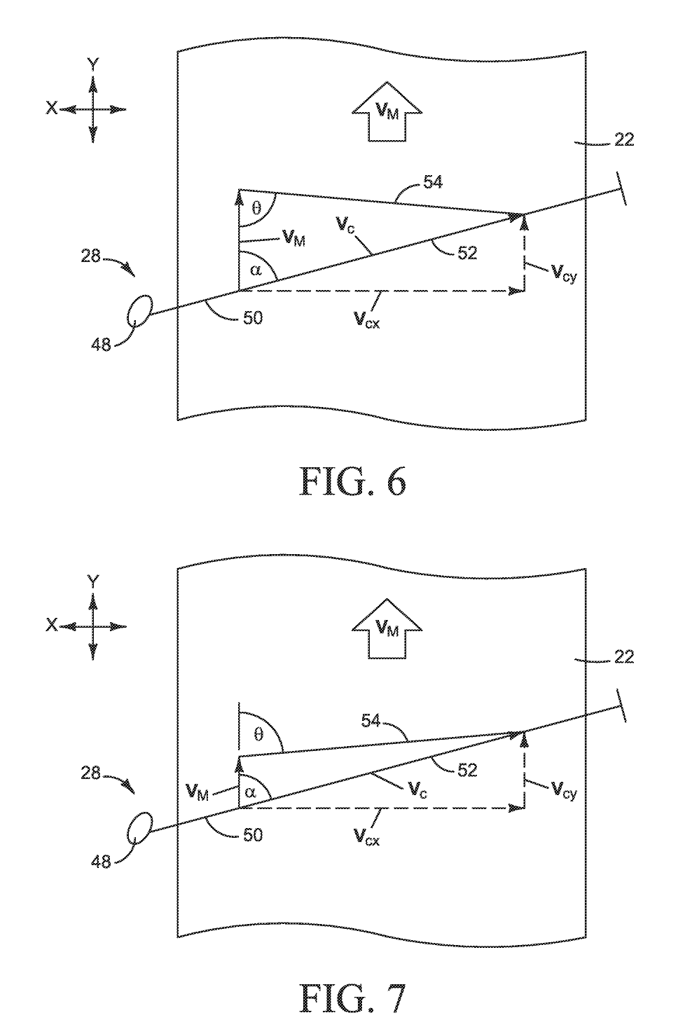

The velocity of cutting tool 48 is designated by a vector V_{C} in FIG. 3. The velocity of media 22 is designated by a vector V_{M} in FIG. 3. The speed of each part (i.e., the magnitude of the velocity vector) is designated V_{C} and V_{M}, respectively. (Velocity V in bold typeface and speed V in italics typeface.) Cutting tool 48 is driven along at a speed V_{C} and at an angle α sufficient to cut the moving media 22 along a straight cut line 54 different from the guide line 52. While it is expect that the cut line will typically be perpendicular to the direction the media moves during the cutting operation for making a square cut, other cut lines are possible as described below with reference to FIGS. 6 and 7. For a square cut line 54 shown in FIG. 5, where guide line 52 is oriented at an acute angle α measured with respect to the direction the media moves, the speed V_{C} of the cutting tool is determined by Equation 1 below.

$${V}_{C} = \frac{{V}_{M}}{cos α} \qquad Equation 1$$

where V_{M} is the speed of the media.

In general, Equation 1 defines the relationship among cutting tool speed V_{C}, guide angle α, and media speed V_{M} for a square cut line. Thus, although the form of Equation 1 above specifies V_{C} as a function of V_{M} and guide angle α, Equation 1 could be rewritten to specify guide angle α as a function of cutting tool speed V_{C} and media speed V_{M}, or to specify media speed V_{M} as a function of cutting tool speed V_{C} and guide angle α.

The velocity of cutting tool 48, V_{C}, can be divided into two components—one component V_{CY} in the same direction media 22 is moving (in the Y direction in FIG. 3) and a second component V_{CX} perpendicular to the direction media 22 is moving (in the X direction in FIG. 3). If the component of cutting tool velocity in the direction of media advance, V_{CY}, has the same magnitude as the media velocity, V_{M}, (i.e., V_{CY}=V_{M}), then the cutter movement on media 22 is perpendicular to the direction of media advance. Thus, the cutting component perpendicular to media 22, V_{CX}, is the only component cutting media 22 and the cut is made as if media 22 was stopped and cutting tool 48 driven straight across media 22 when, in fact, media 22 has never stopped moving.

FIGS. 6 and 7 illustrate cutting media 22 at other than a square cut. Referring to FIGS. 6 and 7, cut line 54 is made at an acute angle θ with respect to the direction media 22 is moving (which is parallel to the edges of media 22, the Y direction in FIGS. 6 and 7). Cut line 54 slopes down from left to right in FIG. 6 and up from left to right in FIG. 7. In either case, the relationship among cutter speed V_{C}, guide angle α, and cut line angle θ is defined by equation 2 below.

$$tan O - = \frac{{V}_{C} sin α}{\vert {V}_{M} - {V}_{C} cos α \vert} \qquad Equation 2$$

where V_{M} is the speed of the media and |V_{M}−V_{C} cos α| is the absolute value of V_{M}−V_{C} cos α.

In one example of an inkjet web printer 10 shown in FIG. 2, in which the media web 22 advances at a speed in the range of 1 inch/second to 8 inches/second, testing indicates a cutter guide angle α in the range of 80° to 86° and a corresponding cutter speed V_{C} according to Equation 1 above makes a good quality square cut for a paper web 22, if web 22 is not under tension during the cutting operation. In one specific example, therefore, a cutter speed V_{C} of 90 inches/second is needed to make a square cut on a paper web media 22 advancing at 8 inches/second for a guide angle αof 85°. Relieving tension (if any) in a media web 22 during cutting improves the quality of the cut. Moving media 22 into cutter 28 slightly faster than moving media 22 away from cutter 28 during a cutting operation helps relieve tension in media 22 at cutter 28. If this technique is used to relieve web tension, then the speed of media 22 moving away from cutter 28 is used for V_{M} in Equations 1 and 2.

The specific parameters noted above do not preclude the use of other acute guide angles α and cutter speeds V_{C}. Rather, these parameters are given to illustrate one example implementation in a real printing environment.

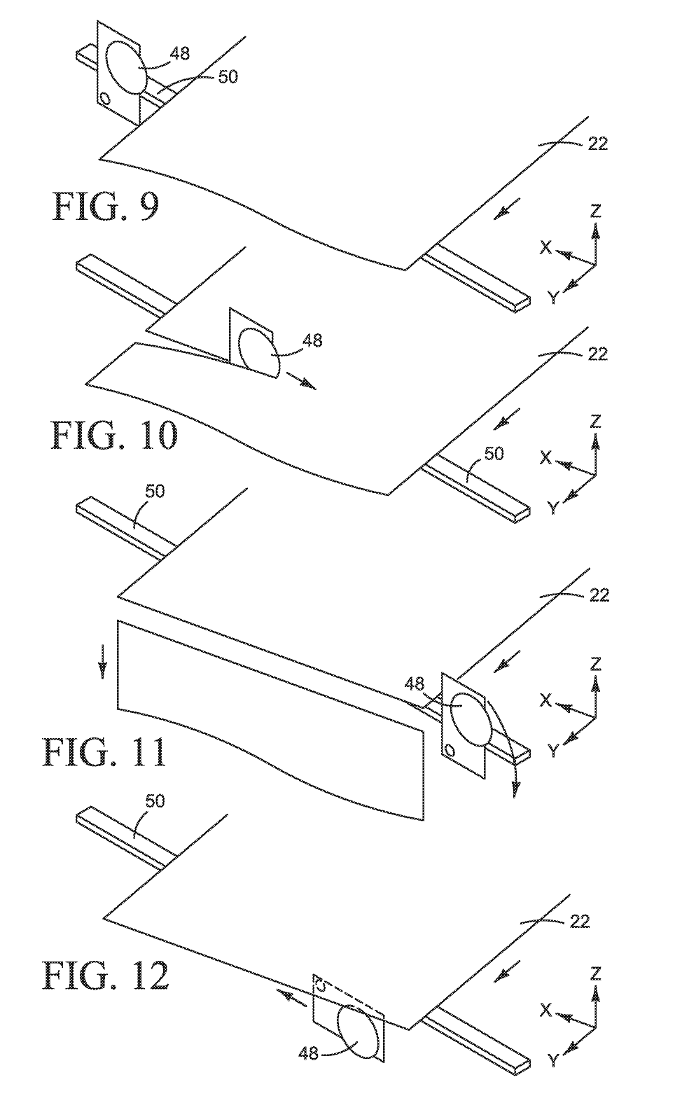

FIG. 8 is a block diagram illustrating one example of a cutter that may be used for a diagonal cutter 28 shown in FIGS. 1-5. FIGS. 9-12 illustrate an operating sequence of a rotary blade cutter as one example for a diagonal cutter shown in FIGS. 1-5. Referring first to FIG. 8, cutter 28 includes a cutting tool 48, linear guide 50, a variable speed motor 56, and a motor controller 58. Controller 58 controls the speed of motor 56 to drive cutting 48 along guide 50 at the desired speed V_{C}. One advantage of at least some examples of the new, diagonal cutter is the ability to adapt conventional variable speed media cutters to the new design. For example, a conventional variable speed rotary blade cutter may be oriented at the desired guide angle α and driven at the desired speed to achieve a square cut, as shown in FIGS. 9-12. Motor controller 58 in FIG. 8 may be integrated into printer controller 20 (FIG. 1) or a separate, programmable motor controller may be used.

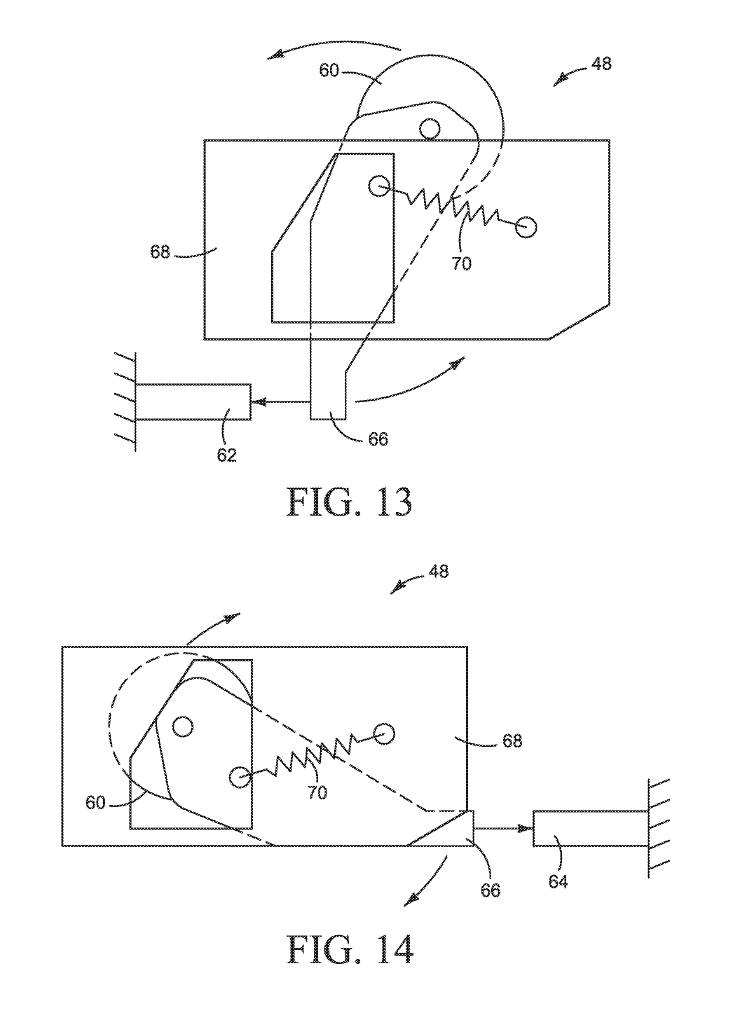

As best seen by comparing FIGS. 9, 10, and 11, a rotary blade cutting tool 48 is driven at the desired speed V_{C} along a stationary, linear guide 50 oriented at the desired angle α, as described above, to produce a square cut across media 22. Then, as shown in FIG. 12, cutting tool 48 is returned to its starting position in preparation for another cutting operation. To return cutting tool 48 to its starting position with stopping media 22, a conventional retractable rotary blade cutting tool 48 such as that shown in FIGS. 13 and 14 may be used. FIG. 13 shows tool 48 with a cutting blade 60 deployed for cutting. FIG. 14 shows tool 48 with cutting blade 60 retracted for returning to the starting position. In the example shown in FIGS. 13 and 14, a blocker 62, 64 at each end of the cutter path engages the end of a lever arm 66 on cutting tool 48 to retract and deploy blade 60, respectively, which is supported in a carriage 68. A biasing spring 70 helps retain blade 60 in each position.

As noted above, the examples and implementations shown in the Figures and described above do not limit the invention. Other examples and implementations are possible. Accordingly, these and other examples, implementations, configurations and details may be made without departing from the spirit and scope of the invention, which is defined in the following claims.

What is claimed is:

1. A cutter for cutting a moving media, comprising:
a stationary, linear guide oriented at an acute angle α measured with respect to a direction the media moves; and
a cutting tool movable along the guide at a speed V_{C} determined by the equation
$${V}_{C} = \frac{{V}_{M}}{cos α}$$
where V_{M} is the speed of the media.

2. The cutter of claim 1, further comprising a variable speed motor operatively connected to the cutting tool to move the cutting tool along the guide at speed V_{C}.

3. The cutter of claim 2, further comprising a motor controller operatively connected to the motor to control the speed of the motor to move the cutting tool along the guide at speed V_{C}.

4. A cutter for cutting a moving media, comprising a cutting tool movable along a first straight line at a speed V_{C} sufficient to cut moving media along a second straight line different from the first straight line.

5. The cutter of claim 4, wherein the second straight line is perpendicular to the direction the media moves during a cutting operation.

6. The cutter of claim 4, wherein:
the first straight line is oriented at an acute angle α measured with respect to a direction the media moves during the cutting operation;
the second straight line is perpendicular to the direction the media moves during a cutting operation and
the cutting tool speed V_{C} is determined by the equation
$${V}_{C} = \frac{{V}_{M}}{cos α}$$
where V_{M} is the speed of the media.

7. The cutter of claim 4, wherein:
the first straight line is oriented at an acute angle α measured with respect to a direction the media moves during the cutting operation;
the second straight line is oriented at an acute angle θ measured with respect to the direction the media moves during the cutting operation; and
the cutting tool speed V_{C} is determined by the equation
$$tan O - = \frac{{V}_{C} sin α}{\vert {V}_{M} - {V}_{C} cos α \vert}$$
where V_{M} is the speed of the media.

8. A method for cutting a moving media, comprising moving a cutting tool along a first straight line at a speed V_{C} to cut the moving media along a second straight line different from the first straight line.

9. The method of claim 8, wherein moving the cutting tool comprises moving the cutting tool at an acute angle α measured with respect to a direction the media is moving at a speed V_{C} determined by the equation
$${V}_{C} = \frac{{V}_{M}}{cos α}$$
where V_{M} is the speed of the moving media.

10. The method of claim 8, wherein moving the cutting tool comprises moving the cutting tool at an acute angle α measured with respect to a direction the media is moving to cut the moving media along a second straight line oriented at an acute angle θ measured with respect to the direction the media is moving at a speed V_{C} determined by the equation
$$tan O - = \frac{{V}_{C} sin α}{\vert {V}_{M} - {V}_{C} cos α \vert}$$
where V_{M} is the speed of the moving media.

11. The method of claim 8, further comprising, while moving the cutting tool, moving the media into the cutting tool faster than moving the web out of the cutting tool.
